(19) United States
(12) Patent Application Publication
(10) Pub. No.: US 2003/0066193 A1
(43) Pub. Date: Apr. 10, 2003

(54) Gel composition that displays changes in temperature through color change and the manufacturing method thereof

(76) Inventor: Chin Cheng Hsu, Taipei City (TW)

Correspondence Address: HSU Chin Cheng, PO Box 82-144, TAIPEI, TW

(21) Appl. No.: 09/970,698

(22) Filed: Oct. 5, 2001

(51) Int. Cl. B29B 7/00

(52) U.S. Cl. 29/896.92; 252/586

(57) ABSTRACT

A gel composition that displays changes in temperature through color changes, characterized in that the gel composition can show changes in temperature by changing its color and the entire color of the composition will change when there is a 2 degree centigrade change in its immediate environment. The method of manufacturing the gel composition includes the steps of: mixing 75% of water by weight with 25% of vinyl alcohol by weight and stirring well the mixture of water and vinyl alcohol, heating the mixture to 70 degrees centigrade to form a gel material, adding temperature sensitive colorant into the gel material and completely dissolving the colorant into the gel material, and filing the gel material into a transparent pocket made of TPU/PVC/EVA film and sealing the pocket.

### BACKGROUND OF THE INVENTION

1. Field of the Invention

This invention is related to a gel composition which displays changes in temperature through color change and the manufacturing method thereof. The gel composition can be used as a protection pad for reducing pressure and illustrating whether the body temperature of a person is normal or not.

2. Description of the Prior Art

As shown in FIG. 1, the conventional protection pad for rehabilitation is simply a rectangular pad 2′ made of foam rubber 1′. However, such a conventional protection pad cannot provide satisfactory resiliency and flexibility so that it will easily deform subject to pressure thereby often causing the user feel uncomfortable and therefore making it unfit for practical use.

Further, the patient who needs rehabilitation must use the protection pad for a long time, so that the wound will be easily infected and inflamed. Hence, the nurse has to check the wound regularly in order to prevent infection and inflammation of the wound, and in case of negligence, the wound will be found infected and inflamed

Therefore, it is an object of the present invention to provide a gel composition which can obviate and mitigate the above-mentioned drawbacks.

### SUMMARY OF THE INVENTION

This invention is related to a gel composition which displays changes in temperature through color change.

It is the primary object of the present invention to provide a gel composition which can show changes in temperature by changing its color, characterized in that the entire color of the composition will change when there is a 2 degree centigrade change in its immediate environment.

It is anther object of the present invention to provide a method of manufacturing the composition which comprises the steps of mixing 75% of water by weight with 25% of vinyl alcohol by weight and stirring well the mixture of water and vinyl alcohol, heating said mixture to 70 degrees centigrade to form a gel material, adding temperature sensitive colorant into the gel material and completely dissolving the colorant into the gel material, and filing the gel material into a transparent pocket made of TPU/PVC/EVA film and sealing the pocket.

It is a further object of the present invention to provide a composition which can be used to make a pillow so that the pillow not only can reduce the pressure applied to the head of a user but also can illustrate whether the body temperature of the user is normal or not.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 illustrates the structure of a conventional protection pad;

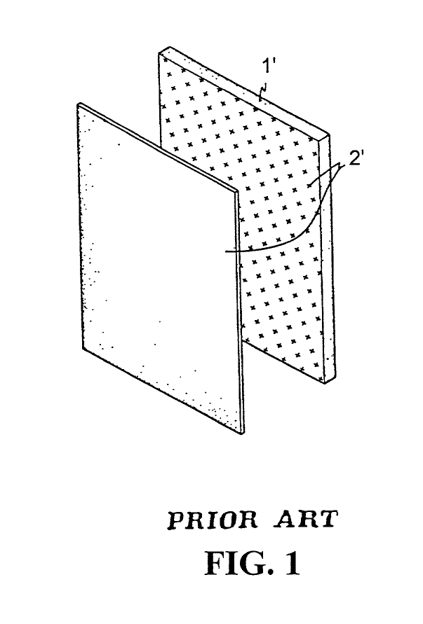

FIG. 2 is a perspective view of a protectional pad according to the present invention; and

FIG. 3 is a working view of the present invention.

### DETAILED DESCRIPTION OF THE PRESENT INVENTION

For the purpose of promoting an understanding of the principles of the invention, reference will now be made to the embodiment illustrated in the drawings. Specific language will be used to describe same. It will, nevertheless, be understood that no limitation of the scope of the invention is thereby intended, alterations and further modifications in the illustrated device, and further applications of the principles of the invention as illustrated herein being contemplated as would normally occur to one skilled in the art to which the invention relates.

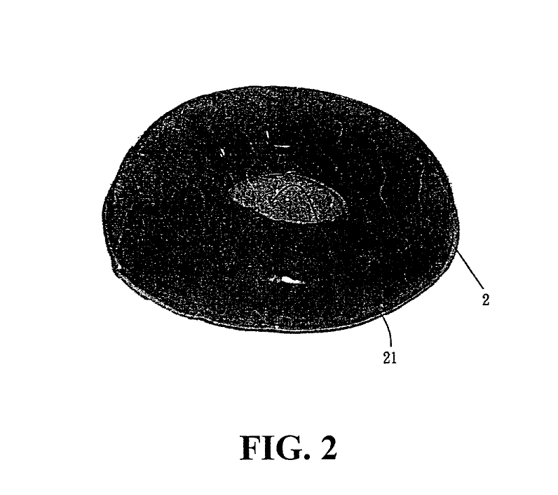

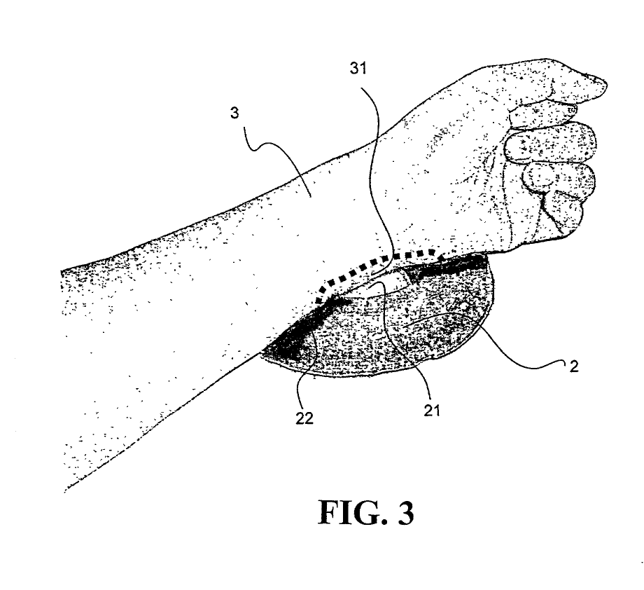

With reference to the drawings and in particular to FIGS. 2 and 3 thereof, the gel composition according to the present invention can show changes in temperature by changing its color. The entire color of the composition of the device will change when there is a 2 degree centigrade change in its immediate environment. The temperature range within this two degree centigrade change is displayed by a combination of the two colors at the lower temperature and the higher temperature. Thus, the device will show the change from one temperature to another by displaying a mixture of two colors.

The method of manufacturing the composition comprises the steps of mixing 75% of water by weight with 25% of vinyl alcohol by weight, stirring well the mixture of water and vinyl alcohol, heating the mixture to 70 degrees centigrade to form a gel-like material, adding temperature sensing colorant into the gel-like material and completely dissolving the colorant in the gel-like material, filling the gel-like material into a transparent pocket made of TPU/PVC/EVA film, and sealing the pocket.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A gel composition that displays changes in temperature through color changes, characterized in that said gel composition shows changes in temperature by changing its color and entire color of said composition will change when there is a 2 degree centigrade change in its immediate environment.

2. A method of manufacturing a gel composition capable of changing color with environmental temperature comprising the steps of:
a. mixing 75% of water by weight with 25% of vinyl alcohol by weight and stirring well mixture of water and vinyl alcohol;
b. heating said mixture to 70 degrees centigrade to form a gel material;
c. adding temperature sensitive colorant into said gel material and completely dissolving said colorant into said gel material; and
d. filling said gel material into a transparent pocket made of TPU/PVC/EVA film and sealing said pocket.
